(19) United States
(12) Patent Application Publication
(10) Pub. No.: US 2016/0281759 A1
(43) Pub. Date: Sep. 29, 2016

(54) Connection System for Detachably Connecting Components and Kit With Such

(71) Applicant: REVELL GMBH, Bunde (DE)

(72) Inventor: Carsten Rosenbohm, Frankfurt am Main (DE)

(21) Appl. No.: 15/078,376

(22) Filed: Mar. 23, 2016

(30) Foreign Application Priority Data
Mar. 24, 2015 (EP) 15160618.3

(51) Int. Cl. F16B 31/00

(52) U.S. Cl. CPC F16B 31/00

(57) ABSTRACT

A connector system for releasably connecting components has a key tool, which has a force transferring head, and a screw element, which has a force receiving head, which can be connected to one another by means of the shapes of the force transferring head and the force receiving head, having shapes designed such that they correspond to one another. Furthermore, at least the force transferring head of the key tool is comprised of a first material, and at least the force receiving head of the screw element is comprised of a second material. The first material and the second material are selected such that the force transferring head and/or the force receiving head are/is reversibly deformable when a force is applied for rotating the key tool that is greater than a definable maximum force. Also disclosed are an associated connector element, an assembly kit having such a connector system, and the use of the assembly kit.

### CROSS-REFERENCE TO RELATED APPLICATIONS

This application claims priority to European Patent Application No. 15160618.3 filed Mar. 24, 2015, the entire content of which is incorporated herein by reference.

### FIELD

The disclosure relates to a connector system for the releasable connection of components, as well as an assembly kit. Furthermore, the disclosure relates to a connector element for the connector system, as well as the use of the connector system for the assembly kit.

### BACKGROUND

The components that are to be connected are understood according to the disclosure to be components of any type that can be releasably assembled, or are to be connected to one another in a force-fit and/or form-fit manner. By way of example, this may concern the connection of a wheel to the hub of a vehicle, but, however, concerns in general the connection of any type of components to one another, which can be produced by means of a rotational movement of a key tool interacting with a threaded element, for example. In the example of the wheel and the hub, the threaded element is a lug nut, which can be screwed on, or tightened, using the key tool. The attachment of a cladding panel to a building, or the connection of shelving components of a furniture kit is also conceivable.

Assembly kits, and in particular technical model kits for assembling miniaturized vehicle, ship, and airplane models, are known. The assembly of individual parts of the kit is often accomplished with adhesive. The screwing together of individual components is also known. The assembly methods known in the field of assembly kits so far require at least a fundamental technical aptitude. Technical assembly kits so far are not suitable, for example, for younger children.

### SUMMARY

The object of the present disclosure is to provide a simple connector system, such that, in particular, even younger children are able to releasably connect components to one another. Furthermore, the object comprises the provision of an assembly kit that has been developed accordingly.

In accordance with the disclosure, this object is achieved with regard to the connector system by the subject matter of claim 1, and with regard to the assembly kit by the subject matter of claim 17. Furthermore, a connector element for achieving the object according to the disclosure is specified by claim 8, and the use of a connector system according to the disclosure is specified in claim 24. Advantageous and beneficial designs of the connector system according to the disclosure, or the assembly kit according to the disclosure, respectively, are specified in the dependent Claims.

The connector system according to the disclosure, for a releasable connecting of components, is provided with a key tool having a force transferring head, and a threaded element, having a force receiving head. The force transferring head and the force receiving head can be connected to one another as a result of their corresponding shapes. Advantageously, it is therefore possible to connect the key tool and the threaded element as desired, in order to enable a transfer of force from the key tool to the threaded element.

As set forth in the present disclosure, it is provided that a user of the connector system exerts a rotational force using the key tool, in order to releasably connect the components of the connector system to one another. Preferably, the threaded element is designed in the fundamental form of a screw, and the key tool is designed in the fundamental form of a screwdriver. The key tool can, however, also be provided with an angular handle, or a handle having some other shape. Furthermore, the threaded element can be designed such that it is designed for producing a snap-on connection, a click-in connection, or comparable connections that can be produced through rotational movement. The rotational force is transferred to the threaded element, or the force receiving head thereof, via the key tool, or the force transferring head thereof. In this manner, the rotational force for producing a releasable connection can be exerted by the user on the connector system and the components to be connected.

Furthermore, at least the force transferring head of the key tool is comprised of a first material, and at least the force receiving head of the threaded element is comprised of a second material.

The first material and the second material can include metals, polymers, composites, alloys or comparable materials, or material compounds/combinations. Thus, as set forth in the present disclosure, a plurality of different pairings of materials for the first and second material is conceivable, in order to beneficially, and as set forth in the present disclosure, obtain corresponding mechanical properties.

Once the releasable connection of two components is obtained using the threaded element, and the user then exerts further rotational forces, which exceed the predetermined maximum force, onto the threaded element with the key tool, a reversible deformation of the force transferring head and/or the force receiving head occurs. Due to the reversible deformation, the force transferring head and the force receiving head slip in relation to one another. As a result, in this case it is no longer possible to transfer a further rotational force from the key tool to the threaded element. The connecting force of the threaded element for the releasable connection of two components cannot be increased beyond the predetermined maximum force. As a result, the definable maximum force also determines the maximum connecting force that is to be provided for the releasable connection of two components. An over-turning of the connector system, in particular the key tool and the threaded element, is not possible. As a result, the connector system according to the disclosure ensures a secure handling, even when used, for example, by persons with little experience, or young children.

According to another embodiment, the reversible deformation of the force transferring head and/or the force receiving head can be generated in at least one contact region between the force transferring head and the force receiving head. The at least one contact region describes, in this case, the contact points, or contact surfaces, respectively, along which the force transferring head and the force receiving head come in contact with one another, such that a rotation force can be transferred from the key tool to the threaded element. The reversible deformation advantageously always occurs in the regions of the force transferring head and/or the force receiving head that border on the contact points for force transfer. The deformation regions can extend only on the surface, or they can extend into the depth of the material of the force transferring head and/or the force receiving head. In this manner, the scope of the reversible deformation can be adjusted in a targeted manner, depending on the first and second materials, among other factors.

In one embodiment of the present disclosure, the first material has a lower rigidity, in particular a lower compressive resistance and/or a lower torsional strength, than the first material. In particular, the mechanical resistance data of a material is to be understood, as set forth in the present disclosure, taking into account the general expert knowledge fundamental to material sciences, or mechanics. Thus, the rigidities of the first and second materials can be understood with regard to various directions of loading and forms of loading, or can be pronounced in different manners, respectively.

When a rotational force is applied to the connector system, or the key tool in connection with the threaded element, respectively, which force is greater that the previously established maximum force, a lower rigidity of the first or second material should result, in particular, in one of the two materials being more strongly reversibly deformed, at least in the contact regions, than the other material. Advantageously, a rotational force can thus be applied only up to the extent of the predefined maximum force using the connector system according to the disclosure.

According to another embodiment, the first material and the second material are identical. It is thus possible that a polymer be selected for the first and second material, for example, in order to obtain a large, reversible deformation of the force transferring head and the force receiving head when a force that is greater than the maximum force is applied. At the same time, the manufacturing of the connector system according to the disclosure can be executed more cost-effectively by using an identical substance for the first and second material.

In another embodiment, the force transferring head and the force receiving head each have at least two lateral surfaces. In this special case, two lateral surfaces are assumed, as set forth in the present disclosure, such that two opposing lateral surfaces are connected to one another at their two respective ends via a curvature, such that a solid body is formed. Furthermore, the force transferring head and the corresponding force receiving head can exhibit three, four or more lateral surfaces. With regard to the corresponding design of the force transferring head and the force receiving head, it should be taken into account that the one component must have the lateral surfaces on its outer circumference, and the other component must have the lateral surfaces on its inner circumference.

Furthermore, edges between adjacent lateral surfaces are rounded off or flattened, such that when a force is applied that is greater than the maximum force, determined in advance, it is possible to rotate the key tool, in particular the force transferring head, in relation to the threaded element, in particular in relation to the force receiving head. In particular, this means that a rotation of the key tool is enabled or facilitated, due to the rounded or tapered edges, once the predetermined maximum force has been exceeded. The threaded element bears against the components that are to be connected, and exerts a specific joining force, in particular in the longitudinal direction of the threaded element. The threaded element therefore cannot execute any further rotation in relation to the components to be connected once a maximum joining force has been attained. When a rotational force that is greater than the maximum force is applied, the key tool must rotate in relation to the threaded element, which is generally referred to as slipping. The design of the components, i.e. the force transferring head and the force receiving head, having three or more lateral surfaces is advantageous thereby in order to facilitate the sliding of the two components in relation to one another, with a reversible deformation occurring thereby.

According to another embodiment, the force transferring head of the key tool and/or the force receiving head of the threaded element has at least one slot. The at least one slot is designed such that the opposing flanks are reversibly deformable, respectively, in the direction toward the at least one slot, or in the direction away from the at least one slot. The deformation of the opposing flanks in the direction toward the slot corresponds to a narrowing of the at least one slot. The deformation of the flanks in the direction away from the slot corresponds to an expansion, or widening of the at least one slot. If numerous slots are provided, e.g. in a circular arrangement, a deformation of the opposing flanks also occurs.

It may be provided that both the force transferring head as well as the force receiving head each have at least one slot. As set forth in the present disclosure, it is thus conceivable to use a first and second material that are designed such that a reversible deformation occurs, in particular due to the slotted shape of the force transferring head or the force receiving head. Thus, materials having greater rigidity values can also be used, in order to be able to transfer greater rotational forces, or torques, in a targeted manner, if necessary.

In another embodiment, a support element is disposed in the at least one slot in at least one of the opposing flanks of the force transferring head or the force receiving head, such that a reversible deformation of the at least one flank toward the slot can be limited. Limited, as set forth in the present disclosure, means that a reversible deformation of the opposing flanks cannot be executed over the overall design width of the slot. The maximum deformation allowed for by the slot is thus not made full use of, in that support elements are provided, such that the maximum deformation of the opposing flanks is reduced by the support elements, e.g. in that the support elements come in contact with the opposing flanks, and bear against one another.

As set forth in the present disclosure, it is thus possible, by means of a specific design of the at least one slot, to adjust the deformability of the flanks, and at the same time, to reduce the scope of the deformation using the support elements, such that, for example, no irreversible deformation can take place. With the design of the at least one slot, the deformability of the flanks can be adjusted based on the width of the slot and the depth of the slot, or the height of the flanks resulting therefrom, respectively. The adjustment of the maximum deformation of the flanks can be varied based on the shape, size, depth and arrangement of the support elements. Advantageously, the reversible deformation of the force transferring head and the force receiving head is thus adjustable in a targeted manner, in order to be able to obtain a desired maximum force, or an arbitrary maximum torque.

Furthermore, the present disclosure relates to a connector element. The connector element is based on a fundamental construction, having a base body, which has a first free end and a second end. Furthermore, the connector element comprises a stop, which is connected to the second end of the base body, and extends beyond this base body in terms of its width and/or its length.

The stop is designed in particular for the releasable attachment of the connector element in, or on, a component of an assembly kit. In order to prevent a slipping of the connector element, the stop has a base surface, which is at least larger than the cross section of the base body. As a result, stop surfaces are obtained, which are designed for the locking in place, or releasable attachment, of the connector element to an assembly kit component.

In accordance with the disclosure, the base body has a planar front surface and a planar rear surface, which has the same dimensions as the front surface. Furthermore, the base body has two opposing legs, wherein the legs have at least one threaded section on their inner surfaces facing one another.

Because of the design having a planar front surface as well as a planar rear surface, the base body can have a substantially box-shaped form. In particular, the first free end of the base body can be rounded and/or beveled. The end surfaces of the base body, which extend on the perimeter between the planar front surface and the planar rear surface, can accordingly likewise have a substantially planar design, wherein the end surface(s) may or could be interrupted and/or tapered and/or rounded, in particular in the region of the first free end.

The legs have at least one threaded section on their inner surfaces facing one another. In other words, the at least one threaded section is formed, or delimited, respectively, by the inner surfaces of the legs.

In one embodiment, it is possible that the legs merge at the free end of the base body, forming an arched section. The legs can form a ring-shaped or semicircular form with the second end of the base body. The base body is preferably perpendicular to the stop.

The threading axis of the at least one threaded section can run parallel to the lateral extension of the stop, preferably in conjunction with the embodiment, as a result of which embodiment, the legs merge at the free end of the base body, thus forming an arch-shaped section. The lateral extension of the stop is to be understood as the extension of the stop that has the smaller extension in relation to the base surface of the stop. The lateral extension of the stop thus runs parallel to the width of the base body, wherein the width of the base body is defined by the spacing of the rear surface from the front surface of the base body.

The threaded section can have a right-hand thread on one half, and a left-hand thread on the other half. In other words, the threaded section is composed of two subsections, wherein one subsection has a right-hand thread, and the other subsection has a left-hand thread. Preferably, the first half, or the first subsection, respectively, extends from the front surface or rear surface over up to one half of the width of the base body. The second half, or the second subsection, respectively, of the threaded section, extends in a complementary manner thereto, either from the front surface or the rear surface, over up to one half of the width of the base body.

The different threaded sections are only visible through a common perspective. Provided the base body is rotated from the front surface to the rear surface, or vice versa, there is always one right-hand thread. The design of different threaded sections thus serves to ensure that, with a variable construction of the connector element, a screw element can always be screwed into the threaded section of the connector element with the customary right-hand turning.

It is possible that the thread path of the threaded section is interrupted, i.e. discontinuous. In particular, it is conceivable that there is a complete thread path in a thread subsection. Preferably the thread path is only formed in an extension of 180° to 359°, in particular from 200° to 340°.

Furthermore, the threaded section of the connector element can have only a right-hand thread. In this case, it is necessary that the connector element is connected to an assembly kit component in a correct position, or is inserted into the assembly kit component in a correct position.

In another embodiment, the legs of the base body can be designed in the manner of a spur rack. The first free end of the base body can thus be formed by free ends of the leg. At least one threaded section is formed on the inner surfaces of the legs facing one another, or on the inner surfaces of the spur racks. In other words, the threaded section is delimited, or formed, respectively, by the inner surfaces of the spur racks facing one another. The threaded section does not have a continuous thread path according to this embodiment. Instead, thread flanks are only formed on the inner surfaces of the legs, wherein the opposing thread flanks of the first leg and the thread flanks of the second leg, disposed above one another, form the threaded section.

With the present embodiment, having spur rack-type legs, it is conceivable that the thread axis of the at least one threaded section runs perpendicular to the lateral extension and perpendicular to the longitudinal extension of the stop. With respect to the lateral extension, the explanations given above apply. The longitudinal extension of the stop is defined as the extension of the base of the stop that is greater than the lateral extension. The longitudinal extension of the stop runs parallel to the length of the base body. The length of the base body is perpendicular to the width of the base body. Provided that the thread axis of the at least one threaded section runs perpendicular to the lateral extension as well as perpendicular to the longitudinal extension of the stop, the threaded section ends, for example, at the stop for the connector element. A stop surface, in particular the stop surface facing the legs, forms the base of the threaded section, for example. By way of example, the tip of a screw element can bear against this base, provided the connector element is in the joined state.

At least one leg can have a notch and/or a slot on the lateral surface facing away from the threaded section, or on the outer surface facing away from the threaded section, respectively. The notch and/or slot can serve as latching aids. It is conceivable that the notch and/or slot lie on an edge of an assembly kit component that is to be connected to another assembly kit component. The notch can also be referred to as a recess, formed on the outer surface of the leg.

Preferably a notch and/or slot is formed on both outer surfaces of the two legs. Using this notch and/or slot, a pre-latching of the connector element in at least one assembly kit component can be executed. Subsequently, a screw element, or a screw can be inserted in the connector element.

In another embodiment, a latching element and/or an orientation element is formed on the front surface and/or on the rear surface of the base body. This latching element can snap into a recess in an assembly kit component for example. The latching element can be designed, by way of example, as a lug and/or as a teardrop-shaped and/or semi-cylindrical latching element. The recess in the assembly kit component is designed to be complementary, or corresponding to this shape. The orientation element can also be designed, for example, as a lug and/or teardrop-shaped and/or semi-cylindrical element, wherein the recess in an assembly kit component is designed accordingly, such that it is complementary to this shape. The orientation element serves to guide the connector element into an assembly kit component in the correct orientation. This is necessary, for example, when the connector element has only one threaded section with the pre-defined thread orientation. Because of the orientation element, the connector element can be easily inserted in the assembly kit component, or connected to the assembly kit component, respectively, in a predefined position. A latching of the orientation element to the assembly kit component is not absolutely necessary.

An orientation element can then be formed, for example, when the threaded section has only a right-hand thread, and the legs of the connector element merge at the free end of the base body, forming an arch-shaped section.

In one embodiment, it is possible that the orientation element and the latching element are formed as a single component, or element, respectively. In other words, the orientation element can simultaneously be designed as a latching element.

Furthermore, it is provided in one embodiment that the connector system according to the disclosure has a connector element such as that described above. In an advantageous manner, components, or assembly kit components, respectively, can be releasably connected to one another.

Another aspect of the disclosure relates to an assembly kit, comprising at least one connector element, as well as at least one screw and at least two assembly kit components that are to be releasably connected. The assembly kit preferably comprises a correlating number of connector elements and screws.

The at least one screw has a section without threading on an end of a screw body facing toward a screw head. The section without threading is thus provided on the end of the screw body that faces away from the tip of the screw body.

In particular, it is to be taken into account that the at least one screw of the assembly kit can preferably be designed as set forth for the screw element of the connector system according to the disclosure described above. However, the screw of the assembly kit should not be limited exclusively to the concrete design of the screw element. Accordingly, the term “screw” is to be understood to also mean the screw element of the connector system according to the disclosure.

The screw can have a transition region, which is formed between the section without threading and a thread. At least one groove can be provided in this transition region. Furthermore, the transition region can be designed in the manner of steps for example. Starting from the section without threading, there therefore can be a step having a radially encircling end surface facing the thread. The at least one groove is preferably formed in this end surface. Up to four grooves can be disposed in the radially encircling end surface. Furthermore, the groove can generate a supplementary latching of the screw element to the assembly kit component that is to be connected when in the assembled state.

The assembly kit preferably comprises at least two connector elements, wherein at least one connector element has legs, which merge at the free end of the base body, forming an arched section. At least one further connector element has legs in this regard, designed in the manner of spur racks.

The assembly kit can thus comprise at least two connector elements of different designs. Thus, the correct connector element, or the most ideal connecting possibility, can be selected for the respective connection of two assembly kit components that is to be generated. The selection among the different connector elements can also occur such that it is dependent on the assembly situation, i.e. depending on the available space.

At least one component can have a depression, which is designed such that this depression receives the stop on a connector element. First, the free end of the connector element is inserted into and through the depression, such that the stop, in particular the stop surface facing the base body, bears on a depression surface. The depression surface is preferably formed as a border of the opening in the model kit component. Furthermore, the cross section of the opening is preferably adapted to the cross section of the base body of the connector element. The cross section of the opening is preferably slightly larger than the cross section of the base body.

Furthermore, it is possible that at least one assembly kit component has a housing-like receiver. The housing-like receiver has, for example, at least two openings. The axes of the two openings of the housing-like receiver are perpendicular to one another thereby.

The base body of the connector element is inserted through one opening of the housing-like receiver. The at least one further opening serves for the insertion of a screw and/or a bolt. The stop, in particular the stop surface facing the base body, bears on at least one border, or an edge section, of an opening in the housing-like receiver. This opening is the opening in which the base body of the connector element is inserted. In a preferred embodiment, the housing-like receiver has three openings, wherein at least two openings in the housing-like receiver are designed such that they lie opposite one another, or face one another. By way of example, a screw and/or bolt can be inserted into and through these two openings.

According to another embodiment, the assembly kit has a connector system. The at least one screw of the assembly kit is preferably designed in accordance with the screw element of the connector system. The assembly kit thus has at least one screw element, and at least one key tool. In particular, it is provided that the screw of the assembly kit is designed such that it has the properties of the screw element, and fulfills the functions of the screw in the assembly kit. This likewise applies to the components of the screw element, or the screw, respectively, such as, e.g. the force receiving head and the screw head. Preferably, the screw element of the connector system is to be understood to be the screw as set forth for the assembly kit. At the same time, the screw, as set forth for the assembly kit, can also exhibit a different design, wherein the screw still has the properties assigned to it for the assembly kit.

According to another independent Claim, the use of the connector system for the releasable assembly of a technical or functional or modular assembly kit is provided. In particular, it is provided that the connector system is to be used for assembling an assembly kit according to the disclosure. Preferably, model assembly kits having a connector system according to the disclosure, among others, can thus also be used for releasably connecting the individual components of the model assembly kit to one another. Advantageously, the model assembly kit can be assembled in a simple manner by inexperienced persons or young children, using the connector system.

In summary, it can be established that, by using numerous connector elements, as well as numerous screws, or screw elements, respectively, different assembly kit components of an assembly kit can be joined to one another, or attached to one another, respectively. The assembly kit preferably comprises two different embodiments of the connector elements. As a result, wheels and doors, for example, of model vehicles can be movably attached. Furthermore, as a result of the connector system it is impossible to damage assembly kit components by applying too much force, or torque.

The connector element is an easily manipulated connecting tool, which can be readily inserted in a depression and/or a housing-like receiver of an assembly kit component. This is also possible for children ages 5 to 8. Because the screws, or screw elements, respectively, are uniform, it is possible for the child to simply, without having to make a selection regarding the screws, insert these into the threaded sections of the connector elements.

It is possible that the stop of a connector element having two legs, which merge at the free end of the base body, forming an arch-shaped section, has a different design with regard to its dimensions, specifically for a stop of a connector element having legs designed in the manner of spur racks. Because the stops have different designs, it is possible to prevent a connector element having a first design from being inserted in the depression and/or housing-like receiver for a connector element of the second design, for which it is not intended.

### BRIEF DESCRIPTION OF THE DRAWINGS

The disclosure shall be explained in greater detail below, based on exemplary embodiments, with reference to the attached, schematic drawings.

FIGS. 1a and 1b show various views of a key tool in accordance with one possible embodiment of the connector system;

FIGS. 2a and 2b show various views of a screw element in accordance with one possible embodiment of the connector system;

FIGS. 3a, 3b and 3c show various views of the connector element, in accordance with a first embodiment;

FIGS. 4a, 4b and 4c show various views of a connector element in accordance with a second embodiment;

FIGS. 5a and 5b show two assembly kit components to be joined, in accordance with an exploded view and in the assembled state, having a connector element in accordance with the first embodiment; and

FIGS. 6a and 6b show two assembly kit components to be joined, in accordance with an exploded view and in the assembled state, having a connector element in accordance with the second embodiment.

### DETAILED DESCRIPTION

In the following, identical reference symbols shall be used for identical components and components having identical functions. The respective reference symbols, specific to the figures, are used only with respect to the screw element 8 and the screw 40.

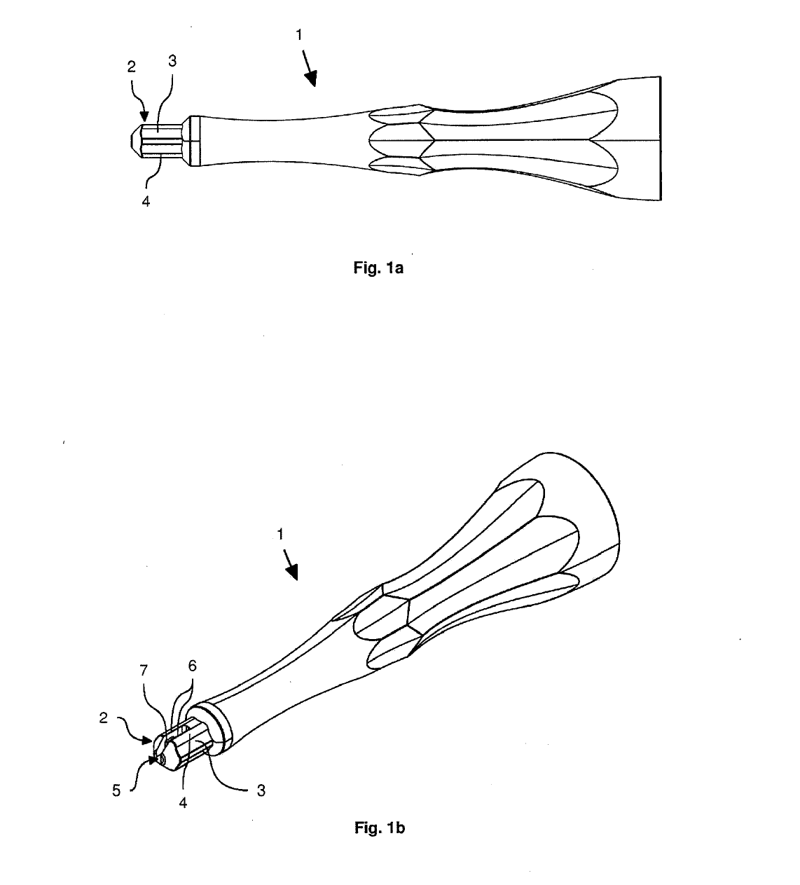

FIGS. 1a and 1b show an exemplary embodiment of a key tool 1 for the connector system according to the disclosure, in a side view and in an isometric depiction. In FIG. 1a it is visible that the key tool 1 preferably has the fundamental design of a screwdriver. Accordingly, the key tool 1 is provided with a suitable handle, which can be grasped along its entire surface. Thus, a rotational force can be applied to the connector system by a user of the connector system in a simple manner.

The key tool 1 has a force transferring head 2. This force transferring head 2 is delimited from the elongated handle in the manner of a step. The force transferring head has numerous lateral surfaces 3, which are provided on the outer surface of the force transferring head 2 in the exemplary embodiment according to FIG. 1a. As set forth in the present disclosure, it is possible that the force transferring head is designed such that the lateral surfaces are formed in an inner circumference, comparable with the design of a typical socket attachment for a mechanical ratchet.

Rounded edges 4 are provided between adjacent lateral surfaces 3 (see FIG. 1b as well). The force transferring head 2 also has a conical tip. Advantageously, the key tool 1 can thus be more easily inserted in a corresponding receiver, because the force transferring head 2 is self-centering to a certain extent when being inserted in the associated receiver.

FIG. 1b shows a force transferring head 2 with a slot 5. The slot 5 has a specific width and depth, and only partially cleaves the force transferring head 2 along it longitudinal direction. Flanks 6 are formed by the slot 5, which lie opposite one another. In accordance with the illustrated exemplary embodiment, a reversible deformation of the force transferring head 2 can be obtained in that the opposing flanks 6 are deformed in the direction toward the slot 5, and the slot 5 thus becomes narrower.

Furthermore, it is indicated to some extent in FIG. 1b that a support element 7 is disposed in the slot 5 on at least one of the flanks 6. In this manner, a reversible deformation of the flanks 6 can be limited, wherein a broader design of the slot 5 enables the reversible deformation of the flanks 6 of the force transferring head with less force. Furthermore, the force transferring head is comprised of a first material, wherein the rest of the key tool can be comprised of the first material in part or in its entirety.

Thus, a definable maximum force for the illustrated exemplary embodiment of the key tool can be established not only based on the selection of the first material of the force transferring head, but also based on the concrete dimensioning of the at least one slot 5 in relation to the dimensions of the force transferring head 2, as well as the possible arrangement and dimensioning of the support elements 7. With a dimensioning of this type, or the specific selection of the first material and/or a second material for an associated screw element, a maximum force for the connector system can be adjusted, or defined, respectively, in advance.

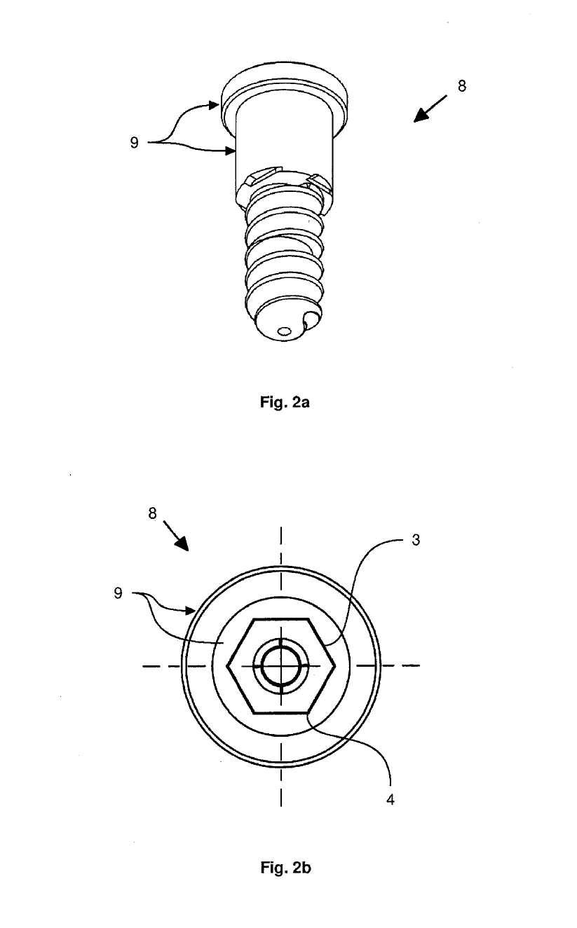

An exemplary embodiment of a screw element 8 for the connector system is depicted in FIGS. 2a and 2b, in an isometric depiction as well as in a top view of the upper surface.

According to FIG. 2a, the screw element 2 has a force receiving head 9, and a thread, in order to be able to releasably connect components to one another. The components of the connector system shown in FIGS. 1a and 2a are therefore designed such that a customary screw connection can be produced by means of the connector system.

The force receiving head 9 is shown in FIG. 2b in a top view of the upper surface. According to this exemplary embodiment, lateral surfaces 3 are formed on an inner circumference of the force receiving head 9. As is also the case with the force transferring head 2 of the key tool 1, it is conceivable in a complementary form, that the lateral surfaces 3 are provided on the outer circumference of the force receiving head 2, such that they are designed to be complementary to the key tool 1, or to the force transferring head 2, respectively. Furthermore, the force transferring head is made from a second material, wherein the screw element can also selectively exhibit the second material, in part or in its entirety.

Between adjacent lateral surfaces 3, edges 4 can be seen in FIG. 2b on the inner circumference of the force receiving head 9. The edges 4 are not rounded off or flattened according to the illustrated exemplary embodiment. In terms of the general, technical understanding, this is not absolutely necessary for obtaining a certain sliding of the force transferring head 2 in relation to the force receiving head 9, when a rotational force is applied that is greater than the a definable maximum force. According to the fundamental general understanding, it is logical in the illustrated design of the force receiving head 9 to round off or flatten, as needed, the corresponding outer edges 4 of the force transferring head 2 appropriately.

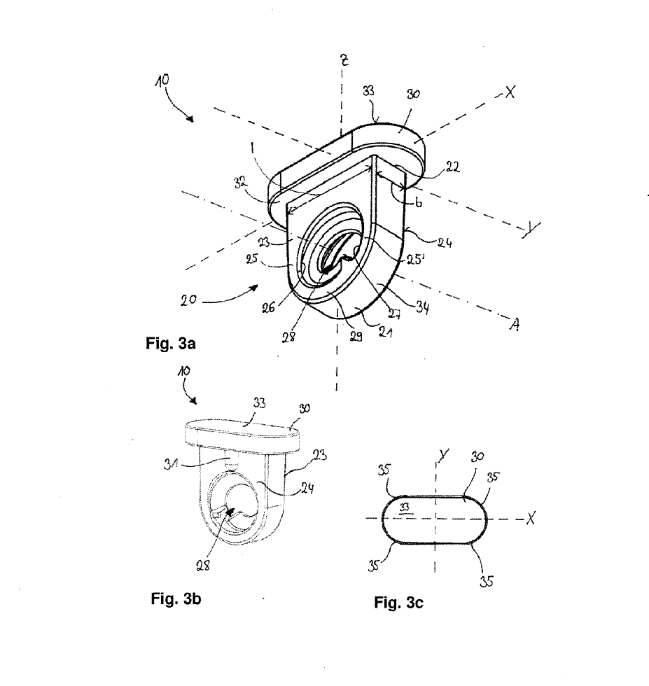

A connector element 10 for an assembly kit is shown in FIGS. 3a to 3c. The connector element 10 has a base body 20, having a first free end 21 and a second end 22. The second end 22 is connected to a stop 30. This connection of the second end 22 of the base body to the stop 30 can also relate to an integral, or monolithic, embodiment of the two elements.

The stop 30 extends beyond the base body 20 in terms of its width b as well as its length 1. In other words, the stop 30 has a stop surface 32, which extends beyond the base body 20 laterally with regard to its width b and its length 1. The stop surface 32 is designed such that it faces the base body 20. The upper surface 33 of the stop is designed such that it faces away from the base body 20. In the depicted example, the stop surface 32 extends beyond the base body 20 over its entire circumference. This means that the cross section of the stop 30 is broader and longer than the cross section of the base body 20.

The base body 20 has a planar front surface 23 and planar rear surface 24 that has the same dimensions as the front surface 23. The front surface 23 and the rear surface 24 are aligned parallel to one another. The end surface 34 of the base body 20 is formed between the front surface 23 and the rear surface 24. The spacing between the front surface 23 and the rear surface 24, or the width of the end surface 34, respectively, defines the width b of the base body 20.

The base body 20 furthermore comprises two opposing legs 25, 25′, wherein the legs 25, 25′ have at least one threaded section 28 on their inner surfaces 26 and 27 facing one another. The inner surfaces 26 and 27 of the legs 25 and 25′ form, or delimit, respectively, the threaded section 28. The legs 25, 25′ merge at the free end 21 of the base body 20, thereby forming an arch-shaped section 29. The legs 25, 25′ thus form a semi-circular section at the free end 21 of the base body 20.

The stop 30 has a rectangular basic shape having rounded corners 35. Because of the rounded corners 35, the stop 30 has the shape of an elongated hole. The upper surface 33 and the stop surface 32 of the stop surface 32 of the stop 30 are designed having the same dimensions. The shape of the upper surface 33 of the stop 30 can be discerned in FIG. 3c. The lateral extension, depicted as the y-axis, is likewise depicted. The longitudinal extension of the stop 30 is illustrated as the x-axis. The lateral extension Y of the stop 30 pertains to the width of the stop 30, which is less than the length of the stop 30.

The length is defined along the x-axis. The thread axis A of the at least one threaded section 28 run parallel to the lateral extension Y of the stop 30 according to the depiction in FIG. 3a. A screw can thus be inserted along this thread axis A into the threaded section 28. The longitudinal extension of the screw thus runs parallel to the lateral extension Y of the stop 30.

Half of the threaded section 28 comprises a right-hand thread, wherein the half corresponds to half of the width b of the base body 20. This means that when the threaded section in the example according to FIG. 3a is viewed, the first, front half of the threaded section 28 has no thread, and the rear half of the threaded section 28 has a right-hand thread. When the connector element 10 is rotated, such that the rear surface 24 is visible (see FIG. 3b), the now front half of the threaded section 28 has a right-hand thread and the then formed rear half of the threaded section 28 has no thread. As can be derived from the depiction, the thread path of the right-hand thread is not complete, i.e. does not extend over the entire 360°; instead, the thread path is interrupted.

A latching element 31 is formed on the rear surface 24 of the base body 20 in the vicinity of the stop 30, in particular bordering on the stop surface 32 (see FIG. 1b), which latching element is semi-cylindrical. This allows it to snap into a recess in an assembly kit component, designed in a complementary shape to the latching element 31. The latching element 31 latches the connector element 10 into an assembly kit component. The latching element 31 can be formed on both the rear surface 24 as well as the front surface 23 of the base body 20. In another embodiment, it is conceivable that a latching element is provided on both the front surface 23 as well as the rear surface 24.

The depicted latching element 31 also serves as an orientation element. The orientation element serves to guide the connector element 10 into an assembly kit component in the correct orientation. The connector element 10 is to be inserted into the assembly kit component such that the rear surface 24, or the part of the threaded section 28 having a right-hand thread is oriented in the direction of a screw that is to be inserted.

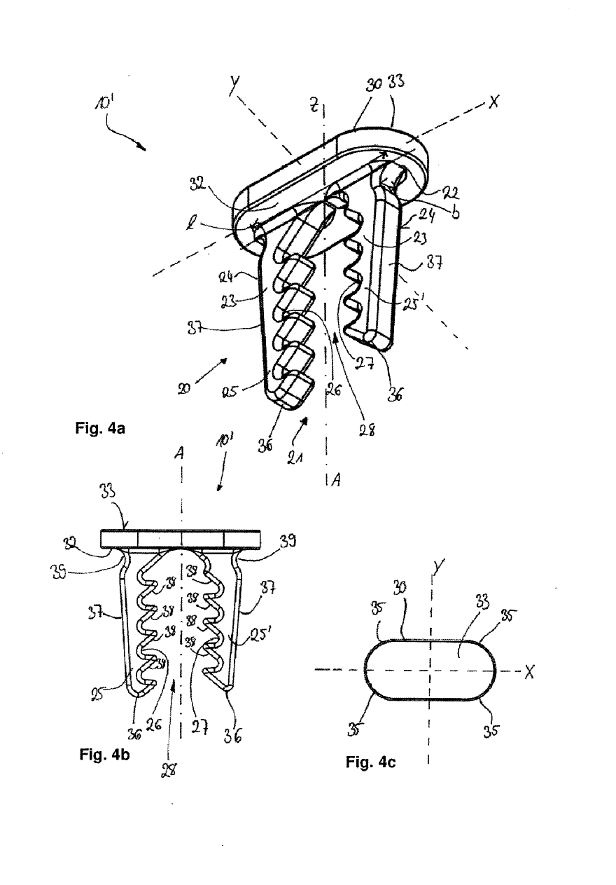

Another possible embodiment of a connector element 10′ is depicted in FIGS. 4a to 4c. With regard to the stop 30 as well as the longitudinal extension X and the lateral extension Y, the same explanations apply that were already provided in the context of the embodiment according to FIGS. 3a to 3c.

The connector element 10′ also has a base body 20 and a stop 30. The base body 20 has a first free end 21 and a second end 22, wherein the stop 30, in particular the stop surface 32, is connected to the second end 22 of the base body 20. It is also conceivable in this context that the stop 30 and the base body 20 have an integral, i.e. monolithic, design. The stop 30 extends beyond the base body 20 in terms of its width b and its length 1. Alternatively, it is also conceivable that the stop 30 extends beyond the base body 20 only in terms of its width b or its length 1.

The base body 20 has a planar front surface 23 and a planar rear surface 24 having the same dimensions of the planar front surface 23. The base body 20 furthermore comprises two legs 25, 25′, which have at least one threaded section 28 on their inner surfaces 26, 27 facing one another. The legs 25, 25′ are designed in the manner of spur racks. This means that both the left leg 25 as well as the right leg 25′ each have threaded flanks 38 disposed one above the other. These threaded flanks 38 are interrupted laterally, i.e. a continuous thread path is not formed. The threaded section 28 is formed by opposing threaded flanks 38 disposed one above the other.

The first free end 21 of the base body 20 is formed by the free ends 36 of the legs 25, 25′. The outer surfaces 37 are not parallel to one another. The outer surfaces 37 of the legs 25 and 25′ that face away from one another run diagonally toward the free ends 36 of the legs 25 and 25′ (see FIG. 4b). Because of this slightly tapered embodiment of the outer surfaces 37, the base body 20 can be more easily inserted in an opening in an assembly kit component. The thread axis A of the at least one threaded section 28 runs perpendicular to both the lateral extension Y as well as the longitudinal extension X of the stop 30 according to the depiction in FIG. 4a. The threaded section 28 thus ends at the stop surface 32. In other words, the thread axis Y is aligned with the extension of the height Y of the stop 30, or the connector element 10′, respectively.

It is depicted in FIG. 4b that the outer surface 37 of the leg 25 and the outer surface 37 of the leg 25′ each have a notch 39. The notch 39 is formed in the region of the second end 22 of the base body 20. The notch 39 can also be referred to as a groove or recess. The notch 39 enables a locking connection to be established with an assembly kit component. For this, the assembly kit component has, for example, a corresponding complementary shape in the region of an opening. It is possible that the outer surface 37 of at least one leg 25, 25′ has a latching element, which has a similar design to that of the latching element 31 according to the embodiment in FIGS. 3a to 3c.

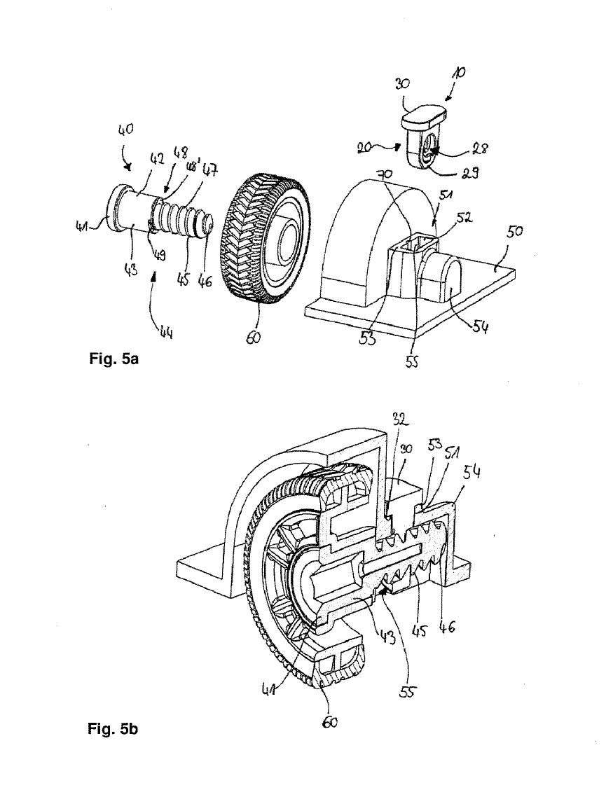

FIG. 5a shows, in sections, an assembly kit comprising a connector element 10, a screw 40, and two assembly kit components 50 and 60 that are to be releasably connected. The connector element 10 is a connector element 10, the legs of which 25, 25′ merge at free ends 21 of the base body 20, thus forming an arch-shaped section 29.

The screw 40 comprises a screw head 41 as well as a screw body 44. At the end 42 facing the screw head 41, the screw body 44 has a section 43 without threading. The screw section 47 facing the tip 46 of the screw 40 has an external thread 45. The screw 40 has a transition region 48, formed between the section 43 without threading and the thread 45 of the screw 40. The transition region 48 has a stepped design, and forms a radially encircling end surface 48′. Four grooves 49 are formed in this end surface 48′, having a uniform, i.e. identical, spacing to one another.

The assembly kit component 60 is a vehicle wheel. The assembly kit component 50, on the other hand, is a body part.

The assembly kit component 50 has a housing-like receiver 51. The free end 21 of the base body 20 of the connector element 10 can be inserted into the opening 52 in the housing-like receiver 51. The stop 30, in particular the stop surface 32, rests on the edge section 53 delimiting the opening 52. The cross section of the opening 52 is slightly larger than the cross section of the base body 20, such that the base body 20 of the connector element 10 can be inserted into the opening 52.

The housing-like receiver 51 receives the base body 20 of the connector element 10 in its entirety. Because the stop 30 extends beyond the base body 20 in terms of its width b and its length 1, the stop 30 rests on the edge section 53.

A recess 70 is formed in the housing-like receiver 51. The latching element 31 of the connector element 10 can be inserted in this recess 70 in the assembly kit component 50. Because the connector element 10 can only be inserted into the assembly kit component 50 in one position, this being such that the latching element 31 is located in the recess 70, the latching element 31 also serves as an orientation element.

The housing-like receiver 51 has another opening 55. The opening 55 can also be referred to as a cut-out. The screw body 44 of the screw 40 is inserted into the opening 55 in the assembled state (see FIG. 5b). A housing extension 54 can likewise been discerned. The tip 46 of the screw 40 is received in this housing extension 54, in particular when the assembly kit is in the assembled state.

The outer thread 54 of the screw section 47 engages with the inner thread of the threaded section 28. By means of the screw head 41, which is wider than the screw body 44, the assembly kit component 60, or the vehicle wheel, respectively, can be attached to the assembly kit component 50. Because the screw 40 has a section 43 without threading, the wheel can rotate about this section 43 without threading.

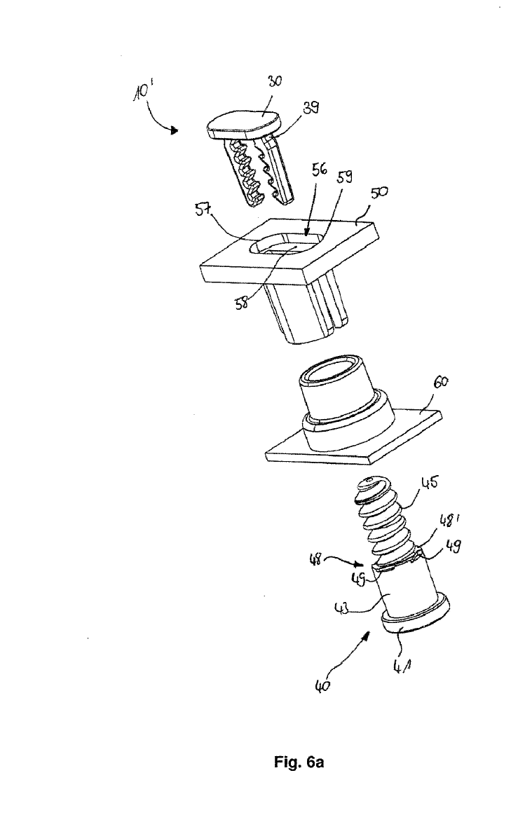

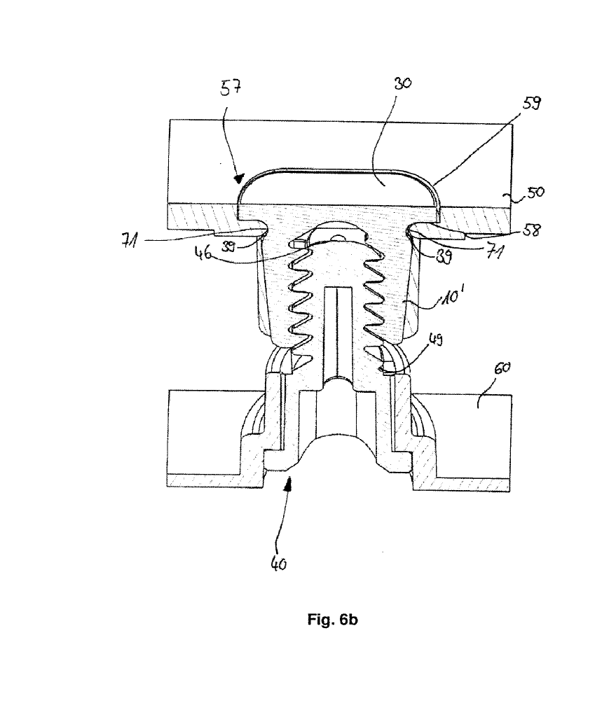

The connection of a connector element 10′, having two spur rack-like legs 25 and 25′, to the assembly kit component 50 is illustrated in FIG. 6a.

The assembly kit component 50 has a depression 57, which is designed such, or has such a shape, that the depression 57 receives the stop 30 of the connector element 10′. The depression 57 is formed around the edge of slot-shaped opening 56. The slot-shaped opening 56 has a cross section shaped such that the base body 20 of the connector element 10′ can be inserted in its entirety into the opening 56. For this, the cross section of the opening 56 is slightly larger than the cross section of the base body 20.

The depression 57 preferably has a depth, such that the stop 30 lies in its entirety within the depression 57 (see FIG. 6b). The upper surface 33 is preferably flush with the edge section 59 of the depression. The stop surface 32 of the stop 30 rests on the depression surface 58.

The screw 40 has a transition region 48 between the section 43 without threading and the thread 45 of the screw 40, designed in the manner of steps and having a radially encircling end surface 48′ having four grooves 49. By means of these grooves 49, the screw 40 can also be latched to the assembly kit component 60. The grooves 49 are distributed evenly, i.e. at equal spacings to one another, on the end surface 48′.

The notches 39 of the connector element 10′ enable the latching joining to the assembly kit component 50 to be established. For this, the assembly kit component 50 has a corresponding complementary shape in the form of bulges 71 in the region of the opening.

### LIST OF REFERENCE SYMBOLS

1 key tool
2 force transferring head
3 lateral surface
4 edge
5 slot
6 flank
7 support element
8 screw element
9 force receiving head
10, 10′ connector element
20 base body
21 first free end
22 second end
23 planar front surface
24 planar rear surface
25, 25′ leg
26 inner surface leg
27 inner surface leg
28 threaded section
29 arch-shaped section
30 stop
31 latching element/orientation element
32 stop surface
33 upper surface
34 end surface
35 rounded corner
36 free end leg
37 outer surface
38 thread flank
39 notch
40 screw
41 screw head
42 end
43 section without threading
44 screw body
45 thread
46 tip
47 screw section
48 transition region
48′ end surface
49 groove
50 assembly kit component
51 housing-like receiver
52 opening
53 edge section
54 housing extension
55 opening
56 opening
57 depression
58 depression surface
59 depression edge section
60 assembly kit component
70 recess assembly kit component
71 bulge
b width base body
l length base body
A thread axis
X longitudinal extension
Y extension of width
Z extension of height

1. A connector system for releasably connecting components, having a key tool, which has a force transferring head, and a screw element, which has a force receiving head, which can be connected to one another, as desired, by means of the shapes of the force transferring head and the force receiving head, designed such that they correspond to one another, wherein at least one force transferring head of the key tool is comprised of a first material, and at least the force receiving head of the screw element is comprised of a second material, wherein the first material and the second material are selected such that the force transferring head and/or the force receiving head are/is reversibly deformable when a force for rotating the key tool is applied that is greater than a definable maximum force.

2. The connector system according to claim 1, wherein the reversible deformation of the force transferring head and/or the force receiving head can be generated in at least one contact region between the force transferring head and the force receiving head.

3. The connector system according to claim 1, wherein the first material or the second material has a lower rigidity, in particular a lower compressive resistance, and/or torsional strength than the second material or the first material.

4. The connector system according to claim 1, wherein the first material and the second material are identical.

5. The connector system according to claim 1, wherein the force transferring head and the force receiving head each have at least two lateral surfaces, wherein edges between adjacent lateral surfaces are rounded off or flattened, such that when a force that is greater than the definable maximum force is applied, a rotation of the key tool, in particular the force transferring head, can occur in relation to the screw element, in particular in relation to the force receiving head.

6. The connector system according to claim 1, wherein the force transferring head of the key tool and/or the force receiving head of the screw element have/has at least one slot, wherein the at least one slot is designed such that opposing flanks can each be reversibly deformed in the direction facing the at least one slot, or in the direction facing away from the at least one slot.

7. The connector system according to claim 6, wherein a support element is disposed in the at least one slot on at least one of the opposing flanks of the force transferring head or the force receiving head, such that a reversible deformation of the at least one flank can be delimited in the direction of the slot.

8. A connector element having a base body, which has a first free end and a second end, having a stop, which is connected to the second end of the base body, and extends beyond this in terms of its width and/or its length, wherein the base body has a planar front surface, and a planar rear surface having the same dimensions as the front surface, and two opposing legs, wherein the legs have at least one threaded section on their inner surfaces facing one another.

9. The connector element according to claim 8, wherein the legs merge at the free end of the base body, thus forming an arch-shaped section.

10. The connector element according to claim 8, wherein a thread axis of the at least one threaded section runs parallel to the lateral extension of the stop.

11. The connector element according to claim 8, wherein the threaded section has a right-hand thread on one half and a left-hand thread on the other half.

12. The connector element according to claim 10, wherein the thread axis of the at least one threaded section runs perpendicular to the lateral extension and perpendicular to the longitudinal extension of the stop.

13. The connector element according to claim 8, wherein the legs have a spur rack-like design.

14. The connector element according to claim 8, wherein at least one leg has a notch and/or groove on the outer surface facing away from the threaded section.

15. The connector element according to claim 8, wherein a latching element and/or orientation element is formed on the front surface and/or the rear surface of the base body.

16. The connector system according to claim 1, wherein the connector system furthermore has a connector element.

17. An assembly having at least one connector element according to claim 8, having at least one screw and having at least two assembly kit components that are to be releasably joined.

18. The assembly kit according to claim 17, wherein a screw body of the screw has a section without threading on an end facing toward a screw head.

19. The assembly kit according to claim 17, wherein the screw has at least one groove in a transition region, formed between a section without threading at the screw head and a thread.

20. The assembly kit according to claim 17, having at least two connector elements, wherein at least one connector element has legs, which merge at the free end of the base body, thus forming an arch-shaped section, and at least one further connector element has legs that are designed in the manner of spur racks.

21. The assembly kit according to claim 17, wherein at least one assembly kit component has a depression, which is designed such that it receives the stop of a connector element.

22. The assembly kit according to claim 17, wherein at least one assembly kit component has a housing-like receiver, which is designed such that it receives at least the base body of a connector element.

23. The assembly kit according to claim 17, wherein the assembly kit has a connector system, wherein the screw is preferably designed according to the screw element.

24. The use of a connector system according to claim 16, for a releasable assembly of a technical or functional or modular assembly kit.
